(19) United States
(12) Patent Application Publication
(10) Pub. No.: US 2021/0267848 A1
(43) Pub. Date: Sep. 2, 2021

(54) PARTITIONING COMPONENT FOR A FEEDING BOTTLE DEVICE AND FEEDING BOTTLE DEVICE

(71) Applicant: KONINKLIJKE PHILIPS N.V., EINDHOVEN (NL)

(72) Inventors: Wiecher Ferdinand KAMPING, ROSMALEN (NL); Narasimha SHASTRI, EINDHOVEN (NL); Arnold AALDERS, SPRANG CAPELLE (NL)

(21) Appl. No.: 17/259,571

(22) PCT Filed: Jul. 17, 2019
(86) PCT No.: PCT/EP2019/069296

§ 371 Date: Jan. 12, 2021

(30) Foreign Application Priority Data
Jul. 23, 2018 (EP) 18184961.3

(51) Int. Cl. A61J 9/04; A61J 11/02

(52) U.S. Cl. CPC A61J 9/04; A61J 11/02

(57) ABSTRACT

The invention relates to a feeding bottle device, feeding method and a partitioning component (210) for a feeding bottle device (100), comprising a teat component (110) defining a teat volume (115) therein and a container component (120) defining a container volume (125therein, the teat component (110) being attachable to the container component (120) by means of an attachment component (130). The partitioning component (210) comprises a first passage (212) allowing a passage of air and liquid between the container volume (125) and the teat volume (115) and a second passage (214) comprising at least one through hole such that the surface tension of an air bubble will not allow the passage into or out of the teat volume (115) up to a predefined pressure difference.

### FIELD OF THE INVENTION

The invention relates to a partitioning component for a feeding bottle device and a feeding bottle device comprising the partitioning component. The invention relates in particular to a partitioning component for a feeding bottle device for feeding an infant. It finds application with the aim of reducing the likelihood of colic-like symptoms, wherein it also applies to other fields.

### BACKGROUND OF THE INVENTION

Colic is a condition some infants suffer from during early months after birth, wherein presence of air in the digestive system is indicated as a major cause. Air ingestion is unavoidable both in breast-feeding and bottle-feeding due to the presence of vacuum in the infant's mouth during feeding. However, it is desired to reduce the amount of air ingested by the infant in order to prevent or alleviate colic-like symptoms.

Different strategies are used to minimize air ingestion during feeding, including reducing the effort required by the infant, for instance by reducing the vacuum through providing a venting valve in the bottle. However, air can nevertheless enter into a teat region of the feeding bottle device in case the liquid level within the feeding bottle drops below a certain level and/or the feeding bottle is provided to the infant in a horizontal position, i.e. a volume around the teat region will then only partially be filled by liquid. However, a horizontal or near-horizontal feeding position is preferred since it more closely mimics the natural feeding position.

EP2799058A1 discloses a feeding apparatus comprising a container and a flexible feeding teat for drawing milk from the bottom of the feeding apparatus when the feeder is held in the operating position. A flow restrictor for allowing the passage of liquid feed from a main container chamber into the flexible feeding teat is positioned at a suitable location. The flow restrictor allows that vacuum induced from the infant's sucking on the teat results in liquid being drawn into the teat from the main container chamber. Due to the suitable location of the flow restrictor, a filling level of the teat can be kept high, even at a later feeding stage, i.e. when the amount of liquid in the feeding apparatus gets lower.

WO0003675 discloses an infant feeding device comprising a mouthpiece adapted to deliver liquid feed to an infant, a grip member shaped to be easily grasped by an infant and means for connecting the mouthpiece to a feed reservoir. A kit for feeding an infant which comprises an infant feeding device as described above, a feed reservoir and a tube which communicates with both the reservoir connection means and the feed reservoir is also provided together with a feed reservoir for use in such a kit.

However, the known feeding apparatus still carries a risk that air is present within the teat volume, for instance air that entered the teat volume through the teat hole when the infant releases the latch, air that entered the teat volume in the form of bubbles present in the liquid drawn via the flow restrictor and the like. Even further, the user manually has to press a part of the teat to fill it before the feeding and to drain it after the feed, which is inconvenient to the user and carries the risk of air remaining in the teat. This air however eventually can be ingested by the infant and bring along undesired and possibly health threatening colic-like symptoms.

### SUMMARY OF THE INVENTION

It has therefore been an object of the present invention to increase the user convenience when operating the feeding bottle device without increasing the risk of colic-like symptoms for the infant while feeding using a feeding bottle device in a horizontal or near-horizontal feeding position.

In a first aspect a partitioning component for a feeding bottle device is provided. The feeding bottle device comprises a teat component defining a teat volume therein and a container component defining a container volume therein, the teat component being attachable to the container component, the partitioning component being configured to separate the teat volume from the container volume when the feeding bottle device is assembled. The partitioning component comprises a first passage allowing a passage of air and liquid between the container volume and the teat volume and a second passage allowing a passage of liquid and preventing a passage of air between the teat volume and the container volume. At least part of the partitioning component comprises a hydrophilic material.

The core concept of the present invention is providing the partition between teat volume and container volume with two passages, wherein only one of the two passages allows the passage of air, while the second passage prevents air from passing through the partitioning component forming the partition. Through adequate arrangement of both passages, it can be avoided that air enters into the teat volume during feeding. For filling and emptying the teat, the first passage is provided as a compensation means which allows, in the case of filling the teat, air to vacate the teat volume and make room for the liquid therein, and, in the case of emptying the teat, air to flow into the teat volume and replace the liquid therein. However, in case of feeding, i.e. when liquid is already filled within the teat volume, e.g. in a horizontal position of the feeding bottle device, liquid is provided on both sides of the first passage, such that no air can pass through the first passage during feeding. Air will be present on the container volume side of the second passage, wherein an amount of air increases during the course of feeding, however, since the second passage blocks or prevents the passage of air, no air can enter the teat volume during feeding. The partitioning component according to the first aspect thus allows for an easy and simple construction, which impedes air from entering the teat volume during feeding. And the hydrophilic material facilitates the passage of liquid, particularly through the second passage.

In an embodiment, the partitioning component can be integrated into another component, such as the teat component or the container component. Thereby, the number of parts can be reduced.

The attachment of the teat component to the container component can be realized by providing suitable attachment means, such as corresponding threads, at the teat component and the container component, respectively. Additionally or alternatively an attachment component, such as a screw ring, can be provided for attaching the teat component to the container component. In an even further embodiment, the attachment means, such as suitable threads, for attaching the teat component and the container component can be integrated into the partitioning component.

A suction pressure present within the container component during feeding can be equalized, for instance, by known air vent valves provided in the feeding bottle device. Thus, also no air will enter into the teat component as a result of the necessary equalization. The benefits of the present invention become most obvious when considering the process of filling and emptying the teat. Since not only the first passage is provided, liquid can enter and vacate the teat via the second passage substantially at the same time while air vacates or enters, respectively, the teat volume. The teat volume fills and empties by gravity in a short time without the user having to manually fill or drain the teat, as would be the case, for instance, if only one passage would be provided. Compared to the known prior art partitioning components, the partitioning component according to the first aspect thus increases user convenience when operating the feeding bottle device.

Air in this context refers generally to ambient air which surrounds the partitioning component or the feeding bottle device, respectively. However, ambient air is of course not necessarily the only gas composition to be prevented from passing through the second passage.

The partitioning component and/or the first and second passages preferentially comprise or are formed in a plastic material in this embodiment, while also other suitable materials can be used in other embodiments.

Teat component, container component and the optional attachment component preferably correspond to similar components known in the context of a prior art feeding bottle device. For instance, the attachment component can comprise a screw-ring for attaching the teat component to the container component.

In a preferred embodiment of the partition component, the first passage is provided eccentrically on the partition component. Expressed differently, the first passage is not arranged concentrically with the partition component. The first passage is then preferably arranged vertically downwards when feeding the infant, such that horizontal feeding is possible until the amount of liquid in the container volume reaches a very low level. Expressed differently, in this preferred embodiment, a separation can be defined for dividing the partition component into two halves, wherein the first passage is provided entirely in one of the two halves.

In a preferred embodiment of the partitioning component, the first passage is provided near or on an edge of the partitioning component. In this context, near the edge should be understood as the first passage being provided closer to the edge than to a center of the partitioning component.

The closer to the edge the first passage is arranged, the lower a liquid level can be in the container volume before air gets into contact with the first passage and eventually can pass through the first passage into the teat volume. Accordingly, a risk of air entering into the teat volume during feeding is reduced even long into the feeding.

In a particularly preferred embodiment the first passage is therefore formed on the edge and thus at the interface of two components, e.g. the partitioning component and the teat component or the container component.

In a preferred embodiment of the partitioning component, at least the region of the second passage comprises the hydrophilic material.

In a further preferred embodiment, the entire partitioning component can comprise or be formed of a hydrophilic material. In general, hydrophobicity is a preferred, special property which qualifies a material to form at least the region of the second passage.

In a preferred embodiment of the partitioning component, the second passage comprises at least one through hole having a diameter of not more than 0.2 mm.

The size of 0.2 mm ensures that air passing through up to a pressure difference of, for instance, 7 mbar, can be prevented. A pressure difference of 7 mbar corresponds to a water column of approximately 7 cm, which corresponds to a typical height of a container component of a feeding bottle device. It is of course contemplated that larger or smaller holes can be provided for smaller or larger container components, respectively.

The through hole having a diameter of 0.2 mm or less impedes the passage of air, in particular of air bubbles present in the container volume. Surface tension of such air bubbles will not allow the passage into or out of the teat volume. Preferably, a plurality of through holes having a diameter of not more than 0.2 mm are provided. Even more preferably, the number of through holes comprised in the second passage is very large, in order to achieve a substantial flow rate when filling or draining the teat.

In a preferred embodiment of the partitioning component, the partitioning component is formed as a porous membrane. In this embodiment, preferably a large percentage of the, including the entire, surface of the partitioning component can act as the second passage, apart from the region formed as the first passage. Expressed differently, the partitioning component can be formed of the first passage and the second passage only, meaning that the entire surface or volume of the partitioning component is either the second passage, i.e. the porous membrane, or the first passage, e.g. an opening. Preferentially, the porous membrane comprises openings or pores of a very small diameter, such that bubbles of air cannot pass there through.

In a further preferred embodiment, the partitioning component comprises an attachment portion at an outer circumferential position thereof for attaching the partitioning component to the feeding bottle device. The attachment portion can either be formed as well as the porous membrane or can comprise a different material. Preferably, the attachment portion comprises the first passage and even more preferably at an outer edge thereof.

In a preferred embodiment of the partitioning component, a surface of the partitioning component comprises at least one protrusion, preferably in the region of the second passage.

The protrusion provided in the region of the second passage fulfill the function of connecting liquid in order to make it flow more easily.

In a preferred embodiment of the partitioning component, a surface of the partitioning component is provided at an angled or curved shape. The angled or curved shape will assist liquid to flow away from the holes, in particular of the second passage, such that filling and emptying the teat is improved.

In a preferred embodiment of the partitioning component, the first passage and the second passage are formed integrally with the partitioning component.

Since the first passage and the second passage are integrated within the partitioning component, no additional parts or elements are to be assembled with the partitioning component in order to allow the teat to become and remain filled while feeding. Thus, in particular cleaning is facilitated due to the reduced number of components. For instance, the partitioning component can be formed as the porous membrane.

In a preferred embodiment of the partitioning component, the first passage is formed as an opening. While it is a requirement for the second passage to restrain the passage of air, the first passage can allow a bidirectional passage of all kinds of fluids. An opening is of course just one simple example of a suitable passage and other passages are contemplated.

It is further preferred that the opening forming the first passage presents a larger diameter than any opening forming the second passage. The larger diameter of the opening of the first passage will facilitate the passage of air, while the smaller diameter of any opening or passage of the second passage will prevent the passage of air.

In an embodiment the first passage comprises an opening with elliptical shape. Advantageously, the elliptical shape of the opening allows to account for user inaccuracies in rotational positioning. More specifically, compared to a circular shape, it allows the same cross sectional surface of the opening to be formed with more distance between a central position of the partitioning component and the onset of the opening. Expressed differently, the shape can be regarded to be flattened towards the edge of the partitioning component. As a result, it allows the teat to remain filled for the longest possible time in a broader range of rotational positions of the partitioning component or the feeding bottle device.

In an embodiment the partitioning component further comprises a sealing material for forming a sealing interface between the partitioning component and at least one of the teat component and the container component. Since the partitioning component preferably fits between an opening of container component and teat component, the partitioning component presents an interface to both the container component and the teat component. Teat component, which is preferably flexible, and container component, which is comparably less flexible, will therefore have different material requirements to provide a sealing interface therewith. Preferably, the sealing material is more flexible than a main material of the partitioning component and is provided in a contact area with the container component. Further preferred, the sealing material is integrated within the partitioning component during manufacture.

In a preferred embodiment, the partitioning component further comprises an orientation indicator configured to be visually noticeable when the feeding bottle device is assembled.

Using the orientation indicator, which is preferably facing up or differently visually noticeable when the feeding bottle device is in an operating or feeding position, the orientation of the partitioning component and therefore directly the orientation of the first and second passages is known. Thereby, a smooth operation of the feeding bottle device and the partitioning component can be ensured, in particular, the first and second passages are directly provided in the correct position for reducing the amount of air in the teat volume in case the orientation indicator is placed in the correct position. In other embodiments, the orientation indicator can additionally or alternatively be noticeable acoustically, such as by beeping in case it is incorrectly positioned, through vibration, or the like. While a position facing upwards or upside the feeding bottle device is exemplarily described for the orientation indicator, also alternative or additional positions, such as a position on a side or on the lower side of the feeding bottle device are contemplated. Likewise, a plurality of indication indicators at different positions can be provided. Also the orientation indicator is preferentially integrated within the partitioning component such that the number of parts is reduced. This further facilitates the aspect of cleaning and assembling the feeding bottle device.

According to a second aspect, a feeding bottle device is provided. The feeding bottle device comprises a teat component defining a teat volume therein, a container component defining a container volume therein, and a partitioning component according to the first aspect, the teat component the container component and the partitioning component being attachable to each other along a contact area.

The feeding bottle device according to this aspect can be combined with any of the embodiments of the partitioning component described above and will likewise experience the advantageous effects described with reference thereto. In particular, an attachment component, such as a screw ring, can be provided for attaching at least two of the teat component, the container component and the partitioning component.

Teat component, container component and optionally the attachment component preferably correspond to similar components known in the context of a prior art feeding bottle device. For instance, the attachment component can comprise a screw-ring for attaching the teat component to the container component. In other embodiments, at least two components, such as teat component and attachment component or partitioning component for instance, can also be integrated within one component. In such embodiment, the integrated components are preferably manufactured through injection molding using two different materials having different material properties. Thereby, for instance, the teat can advantageously remain flexible while the attachment portion is less flexible for ensuring a secure attachment to the container component.

In an embodiment the feeding bottle device further comprises at least one air vent valve for allowing the passage of air from outside the feeding bottle device to within the teat volume or, preferred, the container volume.

The at least one air vent valve allows that air enters the teat volume or the container volume to replace liquid drawn from the container volume trough the feeding of the infant, wherein this air does not have to enter into the feeding bottle device through the teat opening, i.e. allows air entering and vacuum reduction even while the infant is latching on the teat.

According to a third aspect, a feeding method for feeding an infant is provided. The method comprises the steps of assembling a feeding bottle device according to the second aspect with liquid in a container component of the feeding bottle device, filling a teat component with liquid by turning the teat component, feeding the infant with the feeding bottle device maintained in an orientation of below 45 degrees, preferably below 30 degrees and particularly preferred between 10 and 30 degrees, relative to a horizontal axis.

Generally, an orientation of the feeding bottle device is to be understood in the usual sense, i.e. substantially as the direction in which the teat is oriented. Placed on a horizontal surface, the orientation of the feeding bottle device will thus generally be vertically and facing upwards. The orientation can therefore be defined as a line from a bottom of the container component to an end of the teat component, through which milk is delivered. Accordingly, turning the teat component is to be understood as bringing the feeding bottle in an orientation, i.e. the teat facing sufficiently downwards, in which the teat component will be filled with liquid from the container component using gravity.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily a feeding bottle device comprising a partitioning component according to the invention,

FIG. 2 shows schematically and exemplarily a filling state of a teat of the feeding bottle device,

FIG. 3 shows schematically and exemplarily a feeding position of the feeding bottle device, and

FIG. 4 shows schematically and exemplarily a draining state of the teat of the feeding bottle device.

### DETAILED DESCRIPTION OF EMBODIMENTS

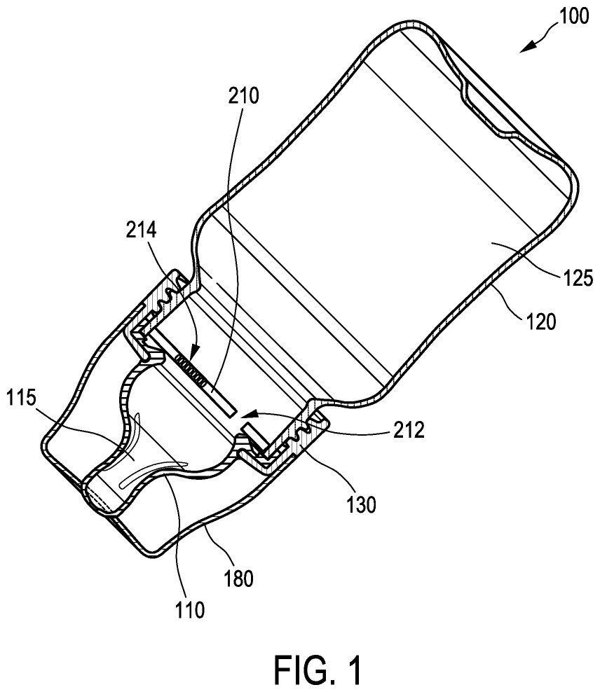

FIG. 1 schematically and exemplarily illustrates a feeding bottle device 100 in an assembled state in cross-sectional view. Feeding bottle device 100 comprises a teat component 110, which is attached to a container component 120 by means of an attachment component 130 in the form of a locking ring. Usually, feeding bottle device 100 and more precisely a container volume 125 within container component 120 is filled with milk, which is then fed to an infant out of teat component 110. For this purpose, feeding bottle device 100 in the assembled state illustrated in FIG. 1 is maintained at an angle which allows milk or other liquid to enter the teat volume 115 within teat component 110. The position in FIG. 1 corresponds to an operating position, in which feeding bottle device 100 is inclined such that a teat component 110 points downwards at a certain angle such that liquid enters a teat volume 115.

The inclination shown in FIG. 1 is unfavorable since it differs from a natural feeding position of an infant, which is substantially horizontal, and since it favors the infant's swallowing of air. Nevertheless, despite being unfavorable, feeding with the illustrated inclination is classically performed in order to keep teat volume 115 filled with liquid and not with air through gravity even if a liquid level within container component 120 drops.

To allow a more horizontal feeding, a partitioning component 210 is provided in a contact area between teat component 110 and container component 120, which separates teat volume 115 on one side and container volume 125 on the other side. The partitioning component 210 comprises a first passage 212 for allowing a passage of air and liquid between container volume 125 and teat volume 115 and a second passage 214 allowing a passage of liquid and preventing a passage of air between the teat volume 115 and the container volume 125.

First passage 212 is arranged at a lower position, i.e. significantly below the liquid level during most of the feeding session even if the feeding bottle device 100 is maintained in the position exemplarily illustrated in FIG. 1 and even in a horizontal feeding position, such that only liquid can enter through first passage 212 into teat volume 115 which will always essentially remain filled with liquid.

The provision of first passage 212 therefore allows that teat volume 115 be filled with liquid even when the feeding bottle device 100 is maintained in a more horizontal feeding position than it would be possible with classical feeding bottle devices. A more horizontal position of feeding bottle device 100, preferably at an angle as low as below 45 degrees inclination with respect to the horizontal direction, corresponds to a more natural and more vertical feeding position of the infant, i.e. the feeding position while breastfeeding, and is therefore preferred over a more inclined feeding position.

Additionally, a second passage 214 is provided in the partitioning component 210. In this example, second passage 214 is formed as small through holes having diameters of less than 0.2 mm in the form of a porous membrane. The second passage 214 is particularly beneficial for filling and emptying the teat before and after feeding the infant, as will be described below.

In some examples, entire partitioning component 210 is formed as a porous membrane, wherein the first passage 212 is formed as an opening therein. Accordingly, the entire partitioning component 210 would allow the passage of liquid between the teat volume 115 and the container volume 125, wherein only at the region of the opening, i.e. corresponding to first passage 212, a passage of air would also be possible.

In other examples, only some regions of the partitioning component 210 would be formed as the porous membrane, i.e. corresponding to the second passage 214, wherein only in the region of the porous membrane the selective passage of liquid would be possible. It should be noted that the second passage 214 is of course not limited to the implementation of a porous membrane, and also a different implementation is possible. For instance, second passage 214 can also be formed as a single or multiple through holes through portioning component 210 showing a sufficiently small diameter, such that air passing there through is prevented. Diameters of 0.2 mm or less will prevent air from passing there through up to a pressure difference of, for instance 7 mbar. Preferentially, the material of the partitioning component 210, at least in the region of the second passage 214, comprises a hydrophilic material in order to ensure that water can pass through easily.

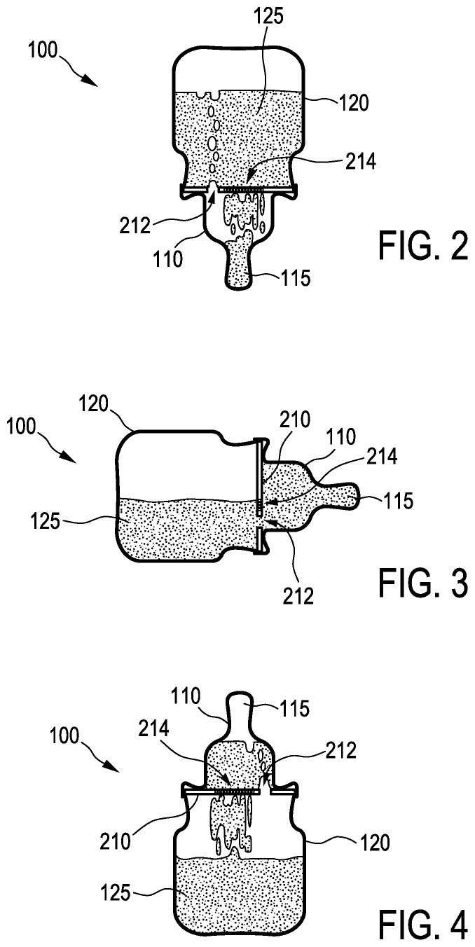

The benefits of providing second passage 214 will be obvious from the exemplary steps of operation of feeding bottle device 100, which are schematically and exemplarily illustrated in FIGS. 2 to 4.

Functioning of feeding bottle device 100 is described as follows. A caregiver assembles feeding bottle device 100 by usually inserting teat component 110 into attachment component 130, optionally then covering this assembly using a cap 180. Container component 120 is filled with milk and then partitioning component 210 is provided in the opening of container volume 125 before attachment component 130 is attached to container component 120, for instance by screwing it on.

After assembly, the filling of teat volume 115 is schematically and exemplarily illustrated in FIG. 2. Feeding bottle device is turned upside down, i.e. teat component 110 is facing vertically down, to allow teat volume 115 to be filled with milk or other liquid provided in container component 120. Through the provision of first passage 212 and second passage 214, teat volume 115 is filled efficiently. Air, which previously was present in teat volume 115, can escape teat volume 115 through first passage 212 and liquid present in container volume 125 can pass through second passage 214 into teat volume 115 at the same time. Without the provision of second passage 214, a user would have to manually and inconveniently press teat component 110 to achieve the filing of teat volume 115 through first passage 212 only.

Once teat volume 115 is filled, feeding of the infant can start.

FIG. 3 schematically and exemplarily illustrates a feeding position in which feeding bottle device 100 is positioned substantially horizontally. Teat volume 115 is completely filled with liquid and liquid drawn from teat component 110 by the infant is replaced through first passage 212 and second passage 214 with liquid of container volume 125. It should be noted that only those parts of second passage 214, which are located under the liquid level in container volume 125, will allow a passage of liquid from container volume 125 to teat volume 115. In the feeding position illustrated in FIG. 3, no air can pass from container volume 125 into teat volume 115, such that air ingestion by the infant can be impeded or at least be made more difficult.

The benefits of second passage 214 will then again become prominent after feeding has ended, i.e. when the feeding bottle device 100 is positioned in the vertical orientation as illustrated schematically and exemplarily in FIG. 4. FIG. 4 illustrates the situation, in which teat volume 115 empties into container volume 125. Only when teat volume 115 is empty, spilling of liquid when opening feeding bottle device 100 can be avoided. At the time while air enters teat volume 115 through first passage 212, liquid drains through second passage 214 into container volume 125 through gravity. Thus, using the forces of gravity only, the emptying of teat component 100 is possible through the provision of first and second passages 212, 214.

In summary, a user who wants use feeding bottle device 100 only has to exert a positional change to feeding bottle device 100 before and after feeding, i.e. turning feeding bottle device 100 upside down before feeding for filling teat component 110 and turning feeding bottle device 100 to the original position after feeding in order to empty teat component 110. No additional and inconvenient operation is necessary.

In order to collect liquid to facilitate the flow of liquid, protrusions can be formed on a surface of partitioning component 210, preferably in the range of second passage 214.

Further, the surface of partitioning component 210 can optionally be provided at an angle, such as inclined or curved, such that gravity will assist liquid to flow away from holds front in second passage 214.

Preferentially, the entire partitioning component 210 is formed as a porous membrane that only allows liquid to pass. Air is blocked by the membrane and can pass only through the opening forming first passage 212. The selective passage allowed by the membrane forming partitioning component 210 improves the more complicated solutions including valves as known in the art.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit, component or device may fulfill the functions of several items recited in the claims. The mere fact that certain measures are recited in mutually different dependent claims does not indicate that a combination of these measures cannot be used to advantage.

1. A partitioning component for a feeding bottle device, the feeding bottle device comprising a teat component defining a teat volume therein and a container component defining a container volume therein, the teat component being attachable to the container component, the partitioning component being configured to separate the teat volume from the container volume when the feeding bottle device is assembled,
characterized in that the partitioning component comprises a first passage allowing a passage of air and liquid between the container volume and the teat volume and a second passage comprising at least one through hole such that the surface tension of an air bubble will not allow the passage into or out of the teat volume up to a predefined pressure difference.

2. The partitioning component according to claim 1, wherein the first passage is provided eccentrically on the partitioning component.

3. The partitioning component according to claim 2, wherein the first passage is provided near or on an edge of the partitioning component.

4. The partitioning component according to claim 1, wherein at least the region of the second passage comprises the hydrophilic material.

5. The partitioning component according to claim 1, wherein the second passage comprises at least one through hole having a diameter of not more than 0.2 mm.

6. The partitioning component according to claim 1, wherein the second passage or the partitioning component is formed as a porous membrane.

7. The partitioning component according to claim 1, wherein a surface of the partitioning component comprises at least one protrusion in the region of the second passage.

8. The partitioning component according to claim 1, wherein a surface of the partitioning component is provided at an angled or curved shape.

9. The partitioning component according to claim 1, wherein the first passage and the second passage are formed integrally with the partitioning component.

10. The partitioning component according to claim 1, further comprising an orientation indicator configured to be visually noticeable when the feeding bottle device is assembled.

11. The partitioning component according to claim 10, wherein the first passage and the second passage are arranged at different distances from the orientation indicator, respectively.

12. The partitioning component according to claim 1, wherein the first passage is formed as an opening.

13. A feeding bottle device comprising:
a teat component defining a teat volume therein,
a container component defining a container volume therein, and
a partitioning component according to claim 1,
the teat component the container component and the partitioning component being attachable to each other along a contact area.

14. The partitioning component according to claim 1, wherein the at least one through hole has a diameter such that the surface tension of an air bubble will not allow the passage into or out of the teat volume up to the predefined pressure difference.

15. The partitioning component according to claim 1, wherein at least part of the partitioning component comprises a hydrophilic material.
